(19) United States
(12) Patent Application Publication
(10) Pub. No.: US 2017/0248753 A1
(43) Pub. Date: Aug. 31, 2017

(54) LIGHT EMITTING DIODE LINEAR WORKLIGHT

(71) Applicant: Gelica Optical Systems Corporation, New Taipei City (TW)

(72) Inventors: Walter Dow WU, New Taipei City (TW); Chih Ming YEN, New Taipei City (TW); Shih Che CHEN, New Taipei City (TW)

(21) Appl. No.: 15/054,105

(22) Filed: Feb. 25, 2016

(51) Int. Cl. F21V 8/00; F21V 17/12; F21V 3/00; F21V 15/01; F21L 4/00; F21V 7/00

(52) U.S. Cl. CPC G02B 6/0096; F21L 4/005; F21V 7/00; F21V 3/00; F21V 15/01; F21V 17/12; F21Y 2115/10

(57) ABSTRACT

A light emitting diode (LED) linear worklight that converts point light into a linear light source is disclosed. The LED linear worklight comprises a linear light device and a power handle that connect together. The power handle holds batteries and comprises an LED module. The linear light device comprises a worklight body and a lens. A transparent light pipe is positioned in a reflecting holder inside the worklight body. The reflecting holder holds the light pipe and reflects light back into the light pipe. The LED module emits light into a light receiving end of the light pipe. The received light travels through the light pipe and is emitted from a light emitting surface of the light pipe. The reflecting holder reflects some of the light emitted from the light emitting surface and directs the light toward the lens and the light exits the worklight body.

### BACKGROUND OF THE INVENTION

Field of the Invention

The present invention relates to lighting devices. More specifically, the present invention discloses a portable worklight device that converts a light emitting diode point light into a linear light source.

Description of the Prior Art

Worklights are utilized to illuminate work areas that can not be adequately illuminated by flashlights.

The conventional worklight uses a fluorescent light tube to produce light. However, fluorescent light tubes are well known to have several disadvantages. Fluorescent light tubes contain a small quantity of mercury and some ballasts contain carcinogens that can be harmful to the environment and to human health. This makes proper disposal of the conventional fluorescent light expensive and potentially dangerous to humans and damaging to the environment.

Additionally, the conventional worklight requires an alternating current (AC) power source to provide power to the fluorescent tube. The need for AC power also requires a power cord to connect the worklight to the AC power source. The requirement for AC power prevents the conventional worklight from being used in a remote location.

Also, the ballast used to slow down changes in the current by modulating the current at a low cycle rate causes the light to flicker which can cause headaches, eye strain, and general eye discomfort.

Therefore, there is need for an effective and environmentally friendly portable worklight that utilizes a light emitting diode to efficiently produce a linear light source.

### SUMMARY OF THE INVENTION

To achieve these and other advantages and in order to overcome the disadvantages of the conventional method in accordance with the purpose of the invention as embodied and broadly described herein, the present invention provides a light emitting diode linear worklight that efficiently converts point light emitted by a light emitting diode module to produce a linear light source.

The light emitting diode (LED) linear worklight of the present invention comprises a linear light device and a power handle.

The linear light device comprises a worklight housing, a transparent or translucent lens, an elongated transparent light pipe, and a reflecting holder for reflecting light and holding the light pipe.

The light pipe is disposed in the reflecting holder and the light pipe and reflecting holder are positioned inside the worklight housing. The lens spans a lens opening in the worklight housing to allow light to exit the linear light device.

The power handle comprises a handle housing for holding direct current (DC) batteries, and an LED module.

When the linear light device is connected to the power handle, batteries in the power handle provides power to the LED module and the LED module emits light into a light receiving end of the light pipe. The received light travels through the light pipe and is emitted from a light emitting surface of the light pipe. The light is then reflected by the reflecting holder or passes through the lens and produces a linear light from the LED linear worklight.

The reflecting holder holds the light pipe and covers the surfaces of the light pipe except for a light emitting surface where light exits the light pipe. The reflecting holder reflects light back into the light pipe where the reflecting holder covers the light pipe. The reflecting holder also reflects light that has exited from the light emitting surface but has not reached the lens. Utilizing the reflecting holder the emitted light intensity and emitted light uniformity are optimized.

As a result, the LED linear worklight of the present invention efficiently converts the point light emitted by the light emitting diode module and coverts the light to provide a linear light source.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is an isometric drawing illustrating a linear light device according to an embodiment of the present invention;

FIG. 2 is a top view drawing illustrating a linear light device according to an embodiment of the present invention;

FIG. 3 is a side view drawing illustrating a linear light device according to an embodiment of the present invention;

FIG. 4 is a side view drawing illustrating a linear light device according to an embodiment of the present invention;

FIG. 5 is a front view drawing illustrating a linear light device according to an embodiment of the present invention;

FIG. 6 is a front view drawing illustrating internal components of a linear light device according to an embodiment of the present invention;

FIG. 7 is a front view drawing illustrating a reflecting holder according to an embodiment of the present invention;

FIG. 8 is an end view drawing illustrating a lens according to an embodiment of the present invention;

FIG. 9A is a drawing illustrating a light pipe according to an embodiment of the present invention;

FIG. 9B is a drawing illustrating a light pipe according to an embodiment of the present invention;

FIG. 10 is a rear view drawing illustrating a worklight housing according to an embodiment of the present invention;

FIG. 11 is a drawing illustrating a light emitting diode linear worklight according to an embodiment of the present invention; and

FIG. 12 is an exploded view drawing illustrating a light emitting diode linear worklight according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

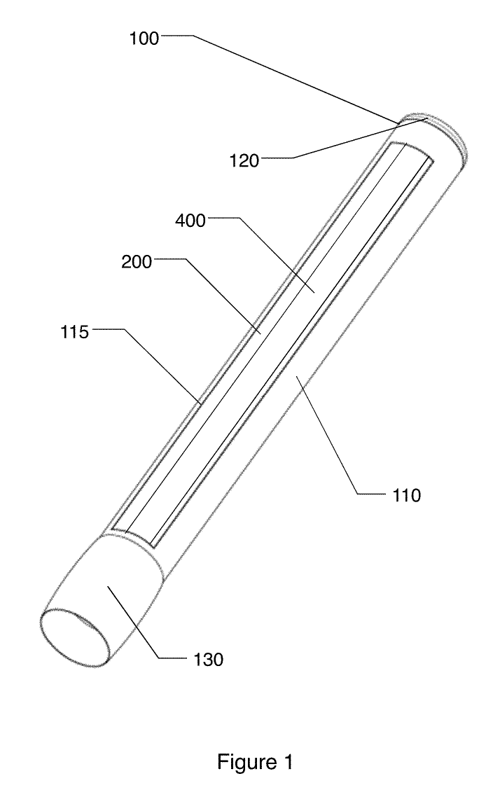

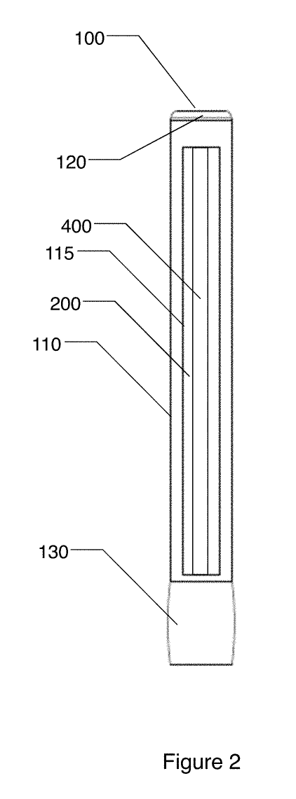

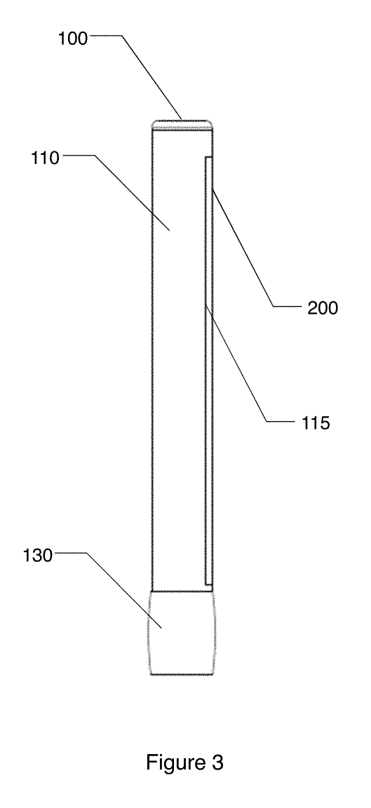

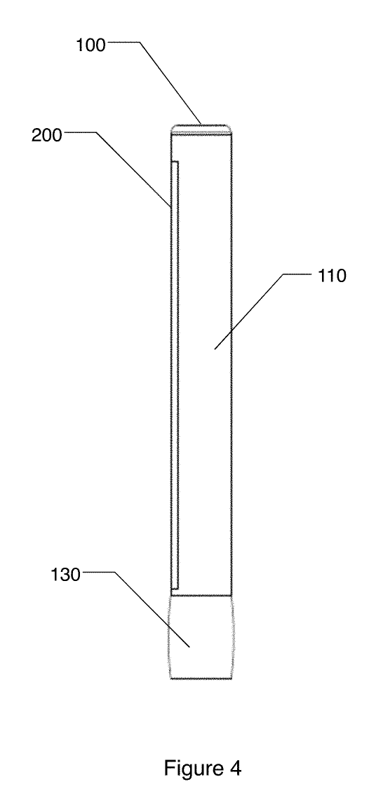

Refer to FIGS. 1-4, which are drawings illustrating a linear light device according to an embodiment of the present invention.

The linear light device 100 comprises a worklight body 110 that provides the main barrel body and holds the internal components of the linear light device 100. The worklight body 110 comprises a front body 130, a rear body 120, and a lens opening 115.

The linear light device 100 further comprises a lens 200 and a light pipe 400.

The light pipe 400 comprises an elongated transparent material and converts point light emitted by a light emitting diode in an attached power handle into linear light.

The lens 200 provides a protective cover over the light pipe 400 to prevent physical contact with the light pipe 400. In an embodiment of the present invention the lens 200 comprises a transparent material to maximize the intensity of emitted light. In another embodiment the lens 200 comprises a translucent material to diffuse the emitted light.

The lens opening 115 in the worklight body 110 is provided for allowing light emitted by the light pipe 400 to pass through the lens 200 and exit the worklight body 110 to produce a linear light source.

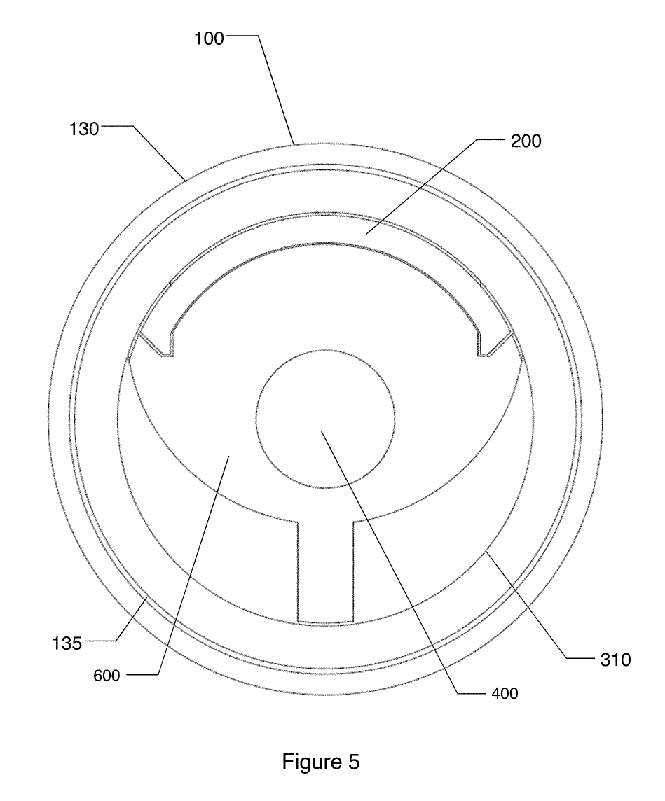

Refer to FIG. 5, which is a front view drawing illustrating a linear light device according to an embodiment of the present invention.

The linear light device 100 further comprises a reflecting holder 600 disposed inside the worklight body.

The light pipe 400 is disposed in and held by the reflecting holder 600.

On the inside surface of the front body 130 body threads 135 are provided for screwing the linear light device 100 onto a power handle.

Parts of the reflecting holder 600 contact the body interior surface 310 of the worklight body. The reflecting holder 600 supports the lens 200 against the body interior surface 310 to hold the lens 200 inside the worklight body.

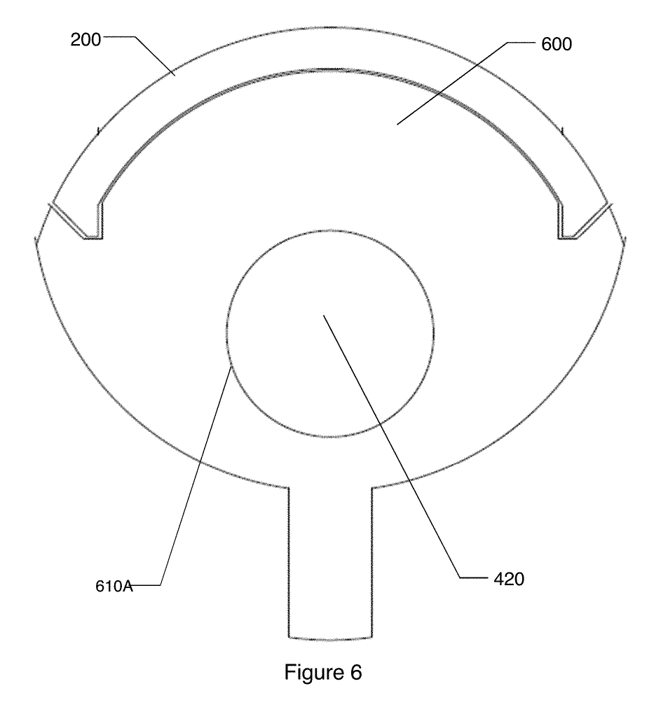

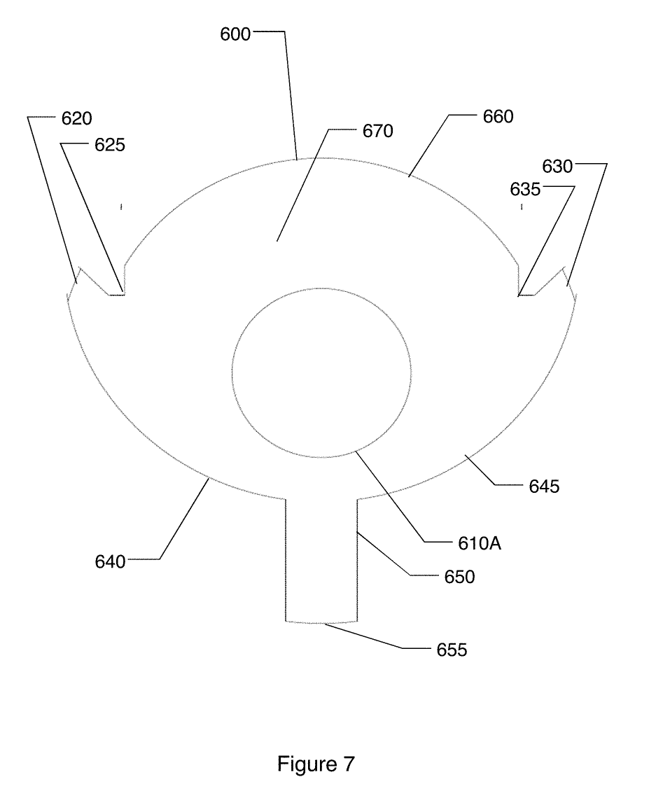

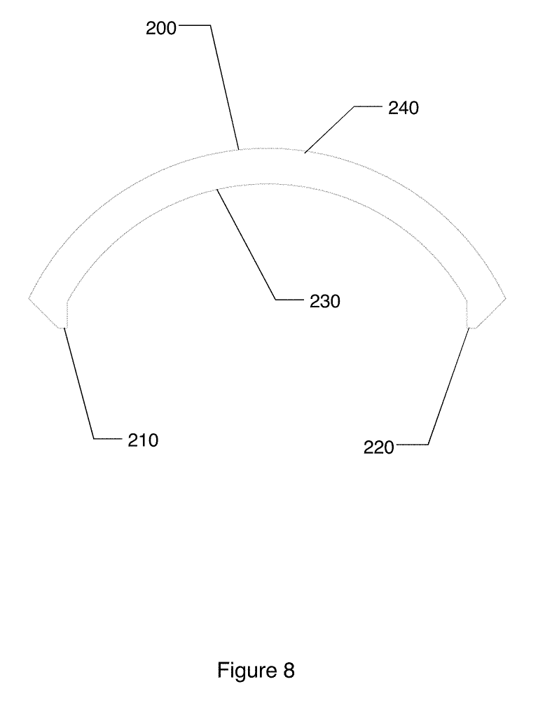

Refer to FIG. 6, which is a front view drawing illustrating internal components of a linear light device according to an embodiment of the present invention, to FIG. 7, which is a front view drawing illustrating a reflecting holder according to an embodiment of the present invention, and to FIG. 8, which is an end view drawing illustrating a lens according to an embodiment of the present invention.

The reflecting holder 600 comprises, for example, an opaque material that reflects light.

The reflecting holder 600 comprises a reflector front opening 610A to allow light emitted by a light emitting diode module in the power handle to enter a light receiving end 420 of the light pipe.

The reflecting holder 600 further comprises a left reflector 640 and a right reflector 645 for reflecting light emitted by the light pipe towards the lens 200 to increase the intensity of emitted light.

A left tip 620 is disposed on an end of the left reflector 640 and a left groove 625 is disposed abutting the top side of the left tip 620.

A right tip 630 is disposed on an end of the right reflector 645 and a right groove 635 is disposed abutting the top side of the right tip 630.

A leg 650 is disposed between the lower surfaces of the left reflector 640 and the right reflector 645. A leg tip 655 on the end of the leg 650 contacts the body interior surface of the worklight body to allow the leg 650 to support the reflecting holder 600.

A front reflector 670 is disposed on the front end of the reflecting holder 600 between the left reflector 640 and the right reflector 645 to prevent light from escaping the front end of the worklight body.

A reflector top 660 is disposed on the top of the front reflector 660.

The lens 200 comprises a lens left arm 210 and a lens right arm 220. The lens left arm 210 mates with the left groove 625 of the reflecting holder 600. The lens right arm 220 mates with the right groove 635 of the reflecting holder 600.

The lens 200 further comprises a lens inner surface 230 and a lens outer surface 240. A portion of the lens inner surface 230 contacts the reflector top 660. Light enters the lens inner surface 230, passes through the lens 200 and exits the lens outer surface 240.

In an embodiment of the present invention the lens 200 comprises a transparent material to optimize light intensity.

In an embodiment of the present invention the lens 200 comprises a translucent material to diffuse the light being emitted.

Refer again to FIG. 5. When the linear light device 100 has been assembled, the left tip 630, the right tip 630, and the leg tip 655 contact the body interior surface 310 which prevents the reflecting holder 600 from moving inside the worklight body.

The left groove 625 and the right groove 635 support the lens 200 and hold the lens 200 against the body interior surface 310 to prevent the lens 200 from moving inside the worklight body.

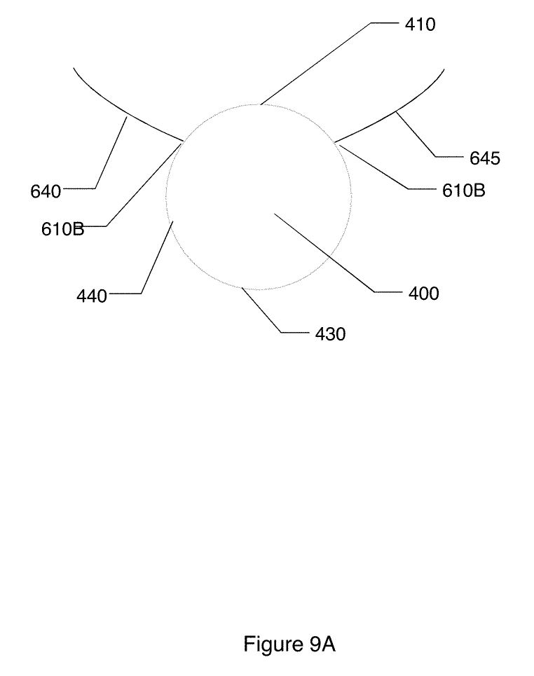

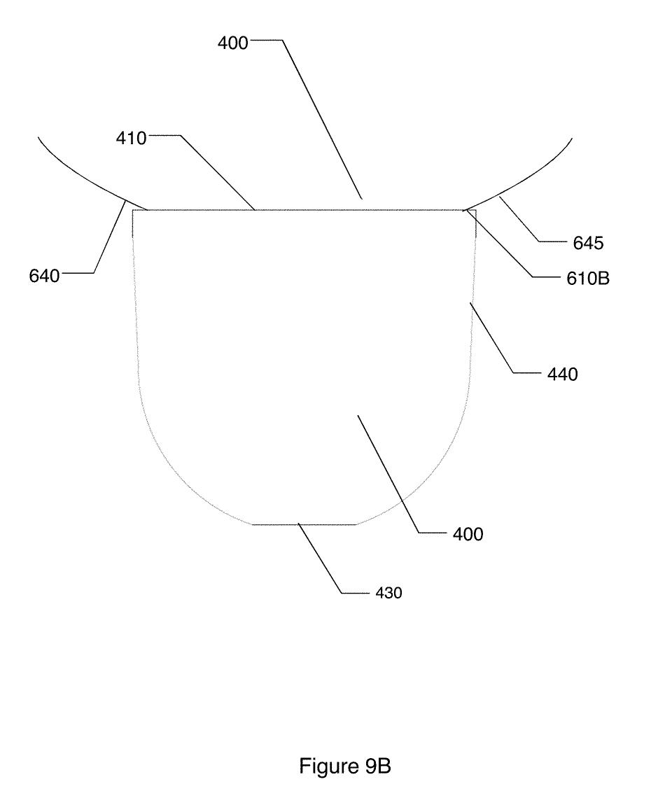

Refer to FIGS. 9A and 9B, which are drawings illustrating light pipes according to embodiments of the present invention.

The light pipe 400 comprises an elongated transparent material.

In the embodiment illustrated in FIG. 9A the light pipe 400 comprises a round light pipe.

In the embodiment illustrated in FIG. 9B the light pipe 400 comprises a closed U-shaped light pipe.

The light pipe 400 comprises a light receiving end 420, a light emitting surface 410, a light pipe bottom 430, and light pipe side surfaces 440 disposed between the light emitting surface 410 and the light pipe bottom 430.

When assembled the light pipe bottom 430 and the light pipe side surfaces 440 sit inside a reflector central opening 610B that extends from the reflector front opening 610A of the reflecting holder 600.

The reflector central opening 610B is disposed between the left reflector 640 and the right reflector 645. The reflector central opening 610B extends from the reflector front opening and is shaped to conform to the shape of the light pipe 400. For example, in the embodiment of FIG. 9A the light pipe is round and the reflector central opening 610B is semicircular in that the reflector central opening extends from the left reflector 640 to the right reflector 645 as a circular indentation to match the round light pipe 400. The reflector central opening 610B covers or surrounds the surfaces such as, for example, side surfaces 440 or the bottom surface 430 while leaving the light emitting surface 410 or a portion of the light emitting surface 410 exposed. In areas where the reflector central opening 610B covers the light pipe 400, light is reflected by the reflector central opening 610B back into the light pipe 400. In the area where the reflector central opening 610B does not cover the light pipe 400, (over the light emitting surface 410), light is allowed to exit the light pipe 400.

The reflector central opening 610B covers the light pipe side surfaces 440 and the light pipe bottom 430 and reflects light back into the light pipe 400 to prevent light from exiting the light pipe 400 except for via the light emitting surface 410.

Additionally, the reflector central opening 610B holds the light pipe 400 inside the reflecting holder 600 to prevent the light pipe 400 from moving inside the worklight body.

In operation, light emitted by the light emitting diode of the power handle enters the light receiving end 420 and travels through the light pipe 400 and exits via the light emitting surface 410.

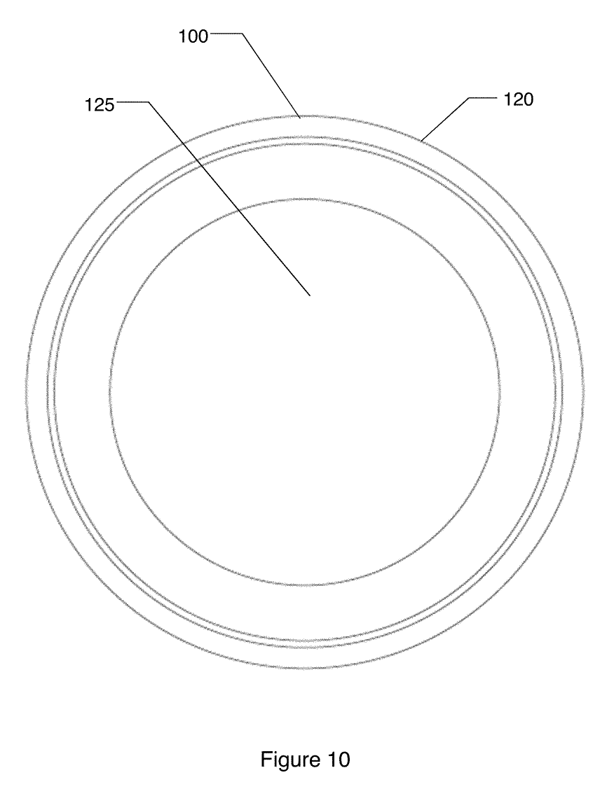

Refer to FIG. 10, which is a rear view drawing illustrating a linear light device according to an embodiment of the present invention.

The rear body 120 further comprises a rear body end 125. The rear body end 125 provides an enclosure end to protect and seal the ends of the internal components of the linear light device 100 inside of the worklight body.

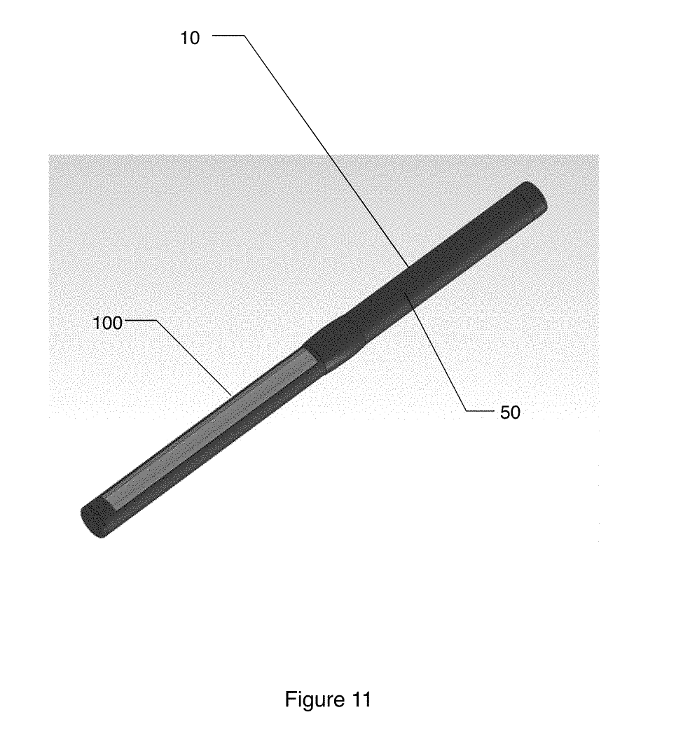

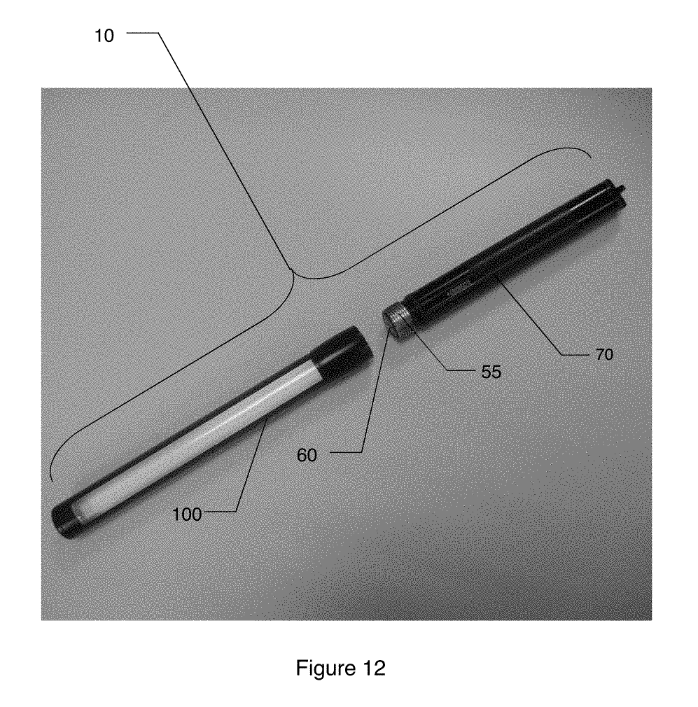

In an embodiment of the present invention the interior surface of the rear body end 125 comprises a reflective surface for reflecting light back into the light pipe or back into the worklight body to increase the intensity of emitted light. Refer to FIGS. 11 and 12, which are drawings illustrating a light emitting diode linear worklight according to an embodiment of the present invention; and

The light emitting diode linear worklight 10 comprises a power handle 50 and the linear light device 100 as described in FIGS. 1-9B.

The power handle 50 comprises a handle housing 70 for holding batteries and allowing a user to grasp the LED linear worklight 10. A light emitting diode module 60 comprising at least one LED is disposed in the power handle 50.

Handle threads 55 on the end of the power handle 50 mate with the body threads to allow the power handle 50 to connect with the linear light device 100.

When the power handle 50 is connected to the linear light device 100, the LED module 60 abuts the light receiving end of the light pipe.

After the power handle 50 is connected with the linear light device 100, the batteries provide power to the LED module 60 which turns the LEDs on and the LED module 60 emits light into the light receiving end of the light pipe. The light travels through the light pipe and exits via the light emitting surface. Some light is reflected by the reflecting holder toward the lens and some light travels directly toward the lens before passing through the lens and exiting the light emitting diode linear worklight 10.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A light emitting diode linear worklight comprising:
a worklight body, the worklight body comprising:
a lens opening disposed in a side of the worklight body for allowing light to exit the worklight body;
a lens disposed across the lens opening;
a light pipe for converting point light into linear light, the light pipe comprising:
a light receiving end for receiving light emitted by a light emitting diode module; and
a light emitting surface for emitting light received via the light receiving end; and
a reflecting holder disposed inside the worklight body for holding the light pipe, the reflecting holder comprising:
a left reflector;
a right reflector; and
a reflector central opening disposed between the left reflector and the right reflector for surrounding surfaces of the light pipe while leaving the light emitting surface exposed.

2. The light emitting diode linear worklight of claim 1, the worklight body further comprising:
body threads disposed on the worklight body for connecting the linear light device to a power handle; and
a body interior surface;
wherein, portions of the reflector holder contact the body interior surface to prevent the reflector holder from moving inside the worklight body.

3. The light emitting diode linear worklight of claim 1, further comprising:
a power handle for connecting to the worklight body, the power handle comprising:
a handle housing for holding at least one battery; and
the light emitting diode module electrically coupling to the at least one battery, the light emitting diode module comprising at least one light emitting diode.

4. The light emitting diode linear worklight of claim 3, the power handle further comprising:
handle threads disposed on the handle housing for mating with body threads on the worklight body.

5. The light emitting diode linear worklight of claim 1, the reflector holder further comprising:
a reflector front opening disposed on a front end of the reflecting holder for allowing light to enter the light receiving end of the light pipe.

6. A light emitting diode linear worklight comprising:
a worklight body, the worklight body comprising:
a lens opening disposed in a side of the worklight body for allowing light to exit the worklight body;
body threads disposed on the worklight body for connecting the linear light device to a power handle; and
a body interior surface;
a lens disposed across the lens opening;
a light pipe for converting point light into linear light, the light pipe comprising:
a light receiving end for receiving light emitted by a light emitting diode module;
a light emitting surface for emitting light received via the light receiving end;
a light pipe bottom disposed opposite the light emitting surface; and
light pipe sides disposed between both sides of the light emitting surface and the light pipe bottom; and
a reflecting holder disposed inside the worklight body for holding the light pipe, the reflecting holder comprising:
a left reflector;
a right reflector; and
a reflector central opening disposed between the left reflector and the right reflector for surrounding the light pipe bottom and the light pipe sides while leaving the light emitting surface exposed.

7. The light emitting diode linear worklight of claim 6, further comprising:
the power handle, the power handle comprising:
a handle housing for holding at least one battery;
handle threads disposed on the handle housing for mating with the body threads; and
the light emitting diode module comprising at least one light emitting diode disposed in the power handle.

8. The light emitting diode linear worklight of claim 6, the lens further comprising:
a lens left arm;
a lens right arm;
a lens inner surface; and
a lens outer surface, the lens inner surface and the lens outer surface disposed between the lens left arm and the lens right arm.

9. The light emitting diode linear worklight of claim 8, the reflecting holder further comprising:
a left tip disposed on the left reflector;
a left groove disposed next to the left tip, the left groove and the left tip mating with the lens left arm;
a right tip disposed on the right reflector;
a right groove disposed next to the right tip, the right groove and the right tip mating with the lens right arm;
wherein the left groove, the left tip, the right groove, and the right tip support the lens and hold the lens against the body interior surface;
a leg disposed between the left reflector and the right reflector;
a leg tip disposed on the leg, the leg tip contacting the body interior surface;
a front reflector disposed on a front end of the reflecting holder;
a reflector top disposed on the front reflector, the reflector top contacting a portion of the lens inner surface; and
a reflector front opening disposed on the front end of the reflecting holder for allowing light to enter the light receiving end of the light pipe.

10. The light emitting diode linear worklight of claim 6, wherein the body threads are disposed inside of the worklight body.

11. The light emitting diode linear worklight of claim 6, wherein edges of the light pipe are held inside the worklight body by the reflecting holder.

12. The light emitting diode linear worklight of claim 6, wherein edges of the lens are held inside the worklight body by the body interior surface.

13. The light emitting diode linear worklight of claim 6, the light pipe comprising an elongated transparent material.

14. The light emitting diode linear worklight of claim 6, the lens comprising transparent or translucent material.

15. A light emitting diode linear worklight comprising:
a power handle, the power handle comprising:
a handle housing for holding at least one battery;
handle threads disposed on the handle housing; and
a light emitting diode module comprising at least one light emitting diode disposed in the power handle; and
a linear light device, the linear light device comprising:
a worklight body, the worklight body comprising:
a lens opening disposed in a side of the worklight body for allowing light to exit the worklight body;
a rear body;
a rear body end disposed on the rear body;
a front body disposed on the worklight body opposite the rear body;
body threads disposed on the worklight body for mating with the handle threads to connect the linear light device and the power handle together; and
a body interior surface;
a lens disposed across the lens opening, the lens comprising:
a lens left arm;
a lens right arm;
a lens inner surface; and
a lens outer surface, the lens inner surface and the lens outer surface disposed between the lens left arm and the lens right arm;
a light pipe for converting point light into linear light, the light pipe comprising:
a light receiving end for receiving light emitted by the light emitting diode module;
a light emitting surface for emitting light received via the light receiving end;
a light pipe bottom disposed opposite the light emitting surface; and
light pipe sides disposed between both sides of the light emitting surface and the light pipe bottom; and
a reflecting holder disposed inside the worklight body for holding the light pipe, the reflecting holder comprising:
a left reflector extending from a left side of the reflector opening;
a left tip disposed on the left reflector;
a left groove disposed next to the left tip, the left groove and the left tip mating with the lens left arm;
a right reflector extending from a right side of the reflector opening;
a right tip disposed on the right reflector;
a right groove disposed next to the right tip, the right groove and the right tip mating with the lens right arm;
wherein the left groove, the left tip, the right groove, and the right tip support the lens and hold the lens against the body interior surface;
a leg disposed between the left reflector and the right reflector;
a leg tip disposed on the leg, the leg tip contacting the body interior surface;
a front reflector disposed on a front end of the reflecting holder;
a reflector top disposed on the front reflector, the reflector top contacting a portion of the lens inner surface.
a reflector front opening disposed on the front end of the reflecting holder for allowing light emitted by the light emitting diode module to enter the light receiving end of the light pipe; and
a reflector central opening extending from the reflector front opening for surrounding the light pipe bottom and the light pipe sides while leaving at least a portion of the light emitting surface exposed.

16. The light emitting diode linear worklight of claim 15, wherein the body threads are disposed inside of the front body.

17. The light emitting diode linear worklight of claim 15, wherein edges of the light pipe are held inside the worklight body by the reflecting holder.

18. The light emitting diode linear worklight of claim 15, wherein edges of the lens are held inside the worklight body by the body interior surface.

19. The light emitting diode linear worklight of claim 15, the light pipe comprising an elongated transparent material.

20. The light emitting diode linear worklight of claim 15, the lens comprising transparent or translucent material.
